(19) United States
(12) Patent Application Publication
(10) Pub. No.: US 2025/0061429 A1
(43) Pub. Date: Feb. 20, 2025

(54) RECEPTACLE STRINGER DEVICE AND SYSTEM

(71) Applicant: John MANNINEN, Paradise, CA (US)

(72) Inventor: John MANNINEN, Paradise, CA (US)

(21) Appl. No.: 18/936,823

(22) Filed: Nov. 4, 2024

Related U.S. Application Data
(63) Continuation-in-part of application No. 17/932,404, filed on Sep. 15, 2022, now Pat. No. 12,137,796.
(60) Provisional application No. 63/674,209, filed on Jul. 22, 2024.

(51) Int. Cl. G06Q 10/30; G06Q 20/24

(52) U.S. Cl. CPC G06Q 10/30; G06Q 20/24

(57) ABSTRACT

According to an aspect of an embodiment, a device may include a rod including a first end and a second end. The rod may include, at the first end, a first stopper configured to permit one or more receptacles to be strung onto the rod in a first direction and to prevent the one or more receptacles from falling off of the rod in a second direction. The rod may include a second stopper attached to the second end of the rod. The second stopper may be configured to prevent the one or more receptacles from coming off the rod in the first direction. The device may include one or more machine-readable identifiers disposed on at least one of the rod, the first stopper, or the second stopper. The one or more machine-readable identifiers may be configurable for the encoding of identification information.

### CROSS-REFERENCE TO RELATED APPLICATIONS

This patent application claims priority to U.S. Provisional Application No. 63/674,209 filed Jul. 22, 2024, and is a continuation-in-part of U.S. patent application Ser. No. 17/932,404 filed Sep. 15, 2022.

### FIELD

The present disclosure generally relates to a receptacle stringer device and system for storing receptacles to be recycled.

### BACKGROUND

Presently, over 50 billion aluminum cans worth close to $2 billion (USD) are thrown away every year in the United States. Current receptacle storage devices and recycling systems have several disadvantages. For example, trash companies with single-line recycling processes lose 3.5 billion aluminum beverage containers annually nationwide. Additionally, recycling containers are usually stored side-by-side with trash containers, which may result in users getting confused and depositing things unsuitable for recycling such as food scraps into the recycling container, thereby contaminating the recyclables. Such confusions may unfortunately result in the recycling collector sorting through messy recyclables or even may result in the collector discarding the contents, including the recyclables, as trash. Further, small towns and/or rural areas may not have a recycling center. For example, it may be cost prohibitive to have a recycling center in a small town or rural area given the investment in land, equipment, and employees required to run current recycling systems. Additionally, present recycling centers use weight scales to determine deposit-refund value. Accordingly, it is common for users to contaminate receptacles by hiding additional weight (e.g., small rocks) inside the receptacles.

The subject matter claimed in the present disclosure is not limited to embodiments that solve any disadvantages or that operate only in environments such as those described above. Rather, this background is only provided to illustrate example technology areas where some embodiments described in the present disclosure may be practiced.

### SUMMARY

According to an aspect of an embodiment, a device may include a rod including a first end and a second end. The rod may include, at the first end, a first stopper configured to permit one or more receptacles to be strung onto the rod in a first direction and to prevent the one or more receptacles from falling off of the rod in a second direction. The rod may include a second stopper attached to the second end of the rod. The second stopper may be configured to prevent the one or more receptacles from coming off the rod in the first direction. The device may include one or more machine-readable identifiers disposed on at least one of the rod, the first stopper, or the second stopper. The one or more machine-readable identifiers may be configurable for the encoding of identification information.

According to an aspect of an embodiment, a method may include scanning, using one or more sensors, at least one machine-readable identifier disposed on a receptacle stringer device. The method may also include determining the number of receptacles retained on the receptacle stringer device. The method may further include depositing the receptacle stringer device with the receptacles retained on the receptacle stringer device into a container to be recycled. Further, in some embodiments, the method may include crediting an account encoded by the machine-readable identifier with a deposit-refund amount based on the number of the receptacles deposited.

The objects and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example environment for a receptacle stringer device and system;

FIGS. 2A, 2B, and 2C illustrate example abbreviated receptacle stringer devices with machine-readable identifiers;

FIG. 3 illustrates an example flowchart of a method of using a receptacle stringer device;

FIGS. 4A and 4B illustrate example readings of machine-readable identifiers on receptacle stringer devices;

FIG. 5 illustrates an example receptacle stringer device with plastic containers strung onto it;

FIG. 6 illustrates example receptacle stringer devices with rods of different widths for accommodating receptacles of different material grades;

FIG. 7 illustrates an example receptacle stringer device with an approximately 90-degree bend;

FIG. 8 illustrates an example computing system;

FIG. 9 illustrates an example receptacle stringer device; and

FIG. 10 illustrates another example receptacle string device, all in accordance with one or more embodiments of the present disclosure.

### DETAILED DESCRIPTION

A device and system for recycling receptacles (e.g., used beverage containers including aluminum cans and/or plastic bottles, steel and/or tin cans used for canned foods, etc.) may benefit from automating how receptacles are stored, deposited, collected, assessed, and/or evaluated. For example, a recycling company may be more efficient at recycling receptacles by using electronic bookkeeping. In some embodiments, the receptacle stringer device and system disclosed herein may simplify collection of recyclable materials and/or may allow for a recycling system to operate with fewer or no employees/personnel.

Traditional recyclable collection systems make it difficult for organizations such as nonprofits, businesses, schools, etc. to use deposit-refund recycling systems to fundraise. For example, a person or multiple people may need to collect, store, and transport several hundreds or even several thousands of receptacles to a recycle center, which may be in a far-away, remote, or otherwise inconvenient location. Additionally, typical recyclable collection systems and/or recycling systems may involve completing paperwork before receiving a reimbursement and generally do not have an option to be reimbursed digitally through systems like gift cards or other electronic/online payment systems (e.g., online banking accounts, Venmo®, Zelle®, PayPal®, Apple Pay®, etc.).

According to some embodiments of the present disclosure, a recycling system may include a receptacle stringer device (e.g., a can stringer) with a machine-readable identifier preprogrammed or reprogrammable to encode for user information (e.g., a user's electronic payment account, bank account, designated third-party organization, etc.).

In some embodiments, the recycling system may include a container (e.g., a collection bin or dumpster) that may be located indoors or outdoors. In some embodiments, the container may be a temporary storage for the receptacles until the receptacles are picked up and delivered to a recycling center for depositing, cleaning, sorting, etc. as part of the recycling process. In some embodiments, the recycling system may include decoding electronics for scanning contents of one or more containers. For example, a telecommunication terminal may be connected to a network to receive information related to quantity of receptacles in a container. In some embodiments, the telecommunication terminal may also be used to transmit and/or receive information related to users. For example, the telecommunication terminal and/or the recycling system generally may be used to electronically dispense reimbursement to a user based on the number of receptacles deposited to be recycled by that user.

In some embodiments, the recycling system may also include a collection opening that restricts items not strung on a receptacle stringer device from being deposited, a sensor for determining user information (e.g., by scanning the machine-readable identifier), a sensor for determining the quantity of receptacles deposited, and/or a network, such that electronic bookkeeping (e.g., how many receptacles were deposited, how much in deposit-refund funds were dispersed, etc.) may be accessed by the user and/or the recycling company digitally/electronically. In some embodiments, one or more sensors may be included in the recycling system such that the status and capacity of the recycling deposit container may be transmitted/communicated to the recycling company. For example, a business may allow users to use a sensor (e.g., a handheld bar code scanner) to scan a machine-readable identifier such that the user's information may be obtained. Additionally or alternatively, the sensor may be used to determine the quantity of receptacles included on a deposited receptacle stringer device. In some embodiments, a network may be used to transfer the user information and/or information about the quantity of receptacles deposited to a financial reward system (e.g., to issue a gift card for the deposit-refund amount). In these and other embodiments, the recycling deposit containers may be stored in a convenient location for pick up to be transferred to a recycling center.

In some embodiments, the disclosed receptacle stringer device may use less material than traditional alternatives for storing recyclable receptacles and may improve visibility of the recyclable receptacles. For example, putting cans into a plastic or paper bag before recycling may involve more material and may obstruct the user's view of the receptacles compared to the receptacle stringer device of the present application. To further the example, the user may forget that a bag contains receptacles and consequently discard recyclable receptacles into a trash. In some recycling systems, plastic bags may be restricted (e.g., single-line recycling systems). For example, plastic bags may be restricted for use in recycling systems because they obstruct visibility and/or could contain trash/non-recyclable items. In some embodiments, the receptacle stringer device may be used in a recycling system that restricts plastic bags. In these and other embodiments, the receptacle stringer device may improve a recycling system by grouping several similar recyclable receptacles together such that they are less likely to be missed and subsequently discarded without being recycled.

Traditionally, deposit-refund systems for recycling have relied on weighing receptacles (e.g., at a recycling center) to determine how much of a refund should be given rather than counting the exact number of receptacles being returned. Some users may take advantage of such a system by adding non-recyclable/non-acceptable material(s) to the inside of receptacles to give an artificially high weight reading, which may result in unfair refunds being paid out and/or increased contamination in the recycling system. Additionally or alternatively, deposit-refund recycling programs may be limited to giving refunds only for bottles and cans that originated in a particular geographical location (e.g., California's Beverage Container Recycling Program is meant to only give California Refund Value (CRV) for bottles and cans from California). Fraud involving redeeming out-of-state bottles and cans may involve millions of dollars. In some embodiments, the disclosed recycling system involving a receptable stringer device with a machine-readable identifier may be used to prevent such fraud as one or more sensors may be used to determine the exact number of receptacles being deposited and/or may be used to scan the receptacles to verify and/or validate that the receptacles are from a particular location.

In some embodiments, the present disclosure may use optical or visual detectors to determine the number of receptacles, thereby negating user motivation to falsely increase weight by contamination. In some embodiments, the disclosed system may provide a name and/or contact information for a feedback method to prevent false contamination from happening in the future. The present disclosure may also provide the user's residency requirements and/or a visual record of the number of receptacles recycled which may be used as proof to refund previously collected receptacle recycling fees.

In some embodiments, the recyclable collection system of the present application may be more convenient and/or may be deployed in more desirable locations than alternative recyclable collection systems. In some embodiments, the recyclable collection system may operate without any human oversight, thus it may be accessible any time rather than being dependent on operating hours and/or employee schedules.

In some embodiments, the container may have features to prevent other items besides recyclable receptacles from being deposited and/or to prevent access to already-deposited contents. Additionally or alternatively, the container may have a way of indicating to a manager, owner, responsible company (e.g., a recycling company) how full the collection bin is (e.g., a notification that the bin needs to be emptied). In some embodiments, a commercial grade trash/dump truck may be dispatched to empty the contents of several containers. In some embodiments, the system may include a visual count of the number of receptacles on each receptacle stringer device and thus may be compared with the weight of the collected receptacles to determine if any of the receptacles may be contaminated. In some embodiments, the recycling process may be completed at a recycling center.

Embodiments of the present disclosure are explained with reference to the accompanying figures.

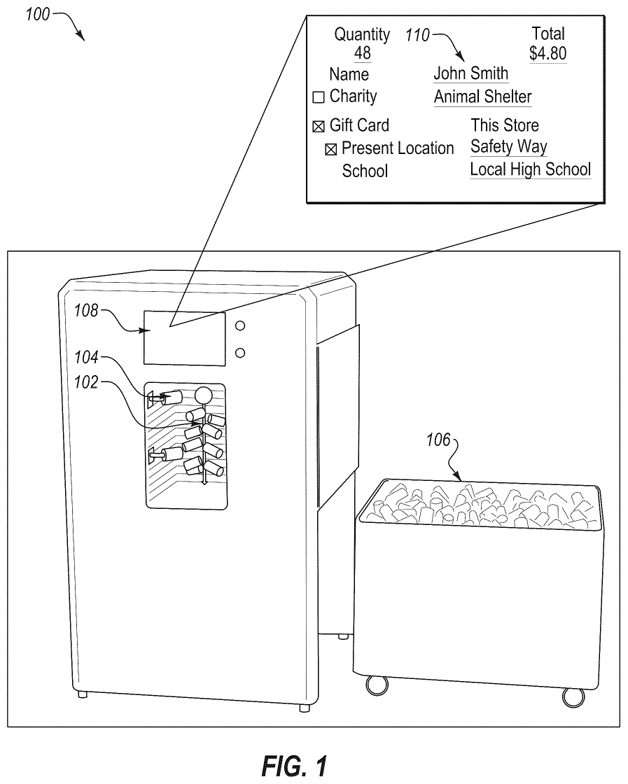

FIG. 1 illustrates an example operating environment 100 for a recyclable receptacle collection system including a receptacle stringer device 102 with a machine-readable identifier. In some embodiments, the environment 100 may include the receptacle stringer device 102, a sensor 104, a container 106, and/or a screen 108.

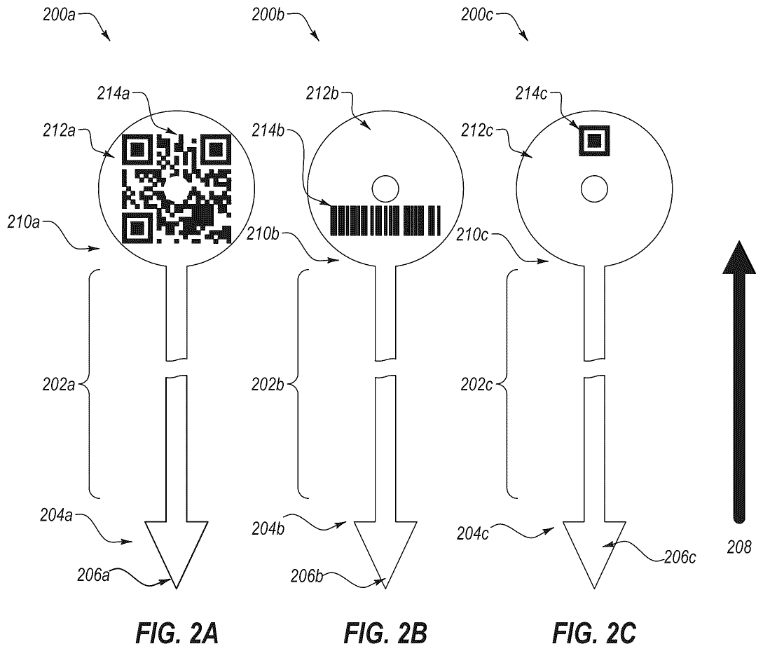

In some embodiments, the receptacle stringer device 102 may be a device or a structure configured to retain empty beverage cans. For example, the receptacle stringer device 102 may be configured thread through one or more beverage cans such that the beverage cans are retained. The structures and/or details of a receptacle stringer device such as the receptacle stringer device 102 may be described in further detail with respect to FIGS. 2A, 2B, and 2C of the present disclosure. In some embodiments, the receptacle stringer device 102 may be manufactured using materials that are lightweight. For example, the receptacle stringer device 102 may be made from cardboard, plastic, and/or metal. In some embodiments, the weight of the receptacle stringer device 102 may be 100-300 grams, 50-100 grams, 25-50 grams, or 10-25 grams. The receptacles may also be made of various materials. For example, the receptacles may be made primarily (e.g., greater than 50%) of aluminum, brass, bronze, cast iron, copper, steel, tin, glass, plastic, paper, and/or cardboard.

In some embodiments, the receptacle stringer device 102 may include a machine-readable identifier configured to represent a user and/or an electronic account accessible by the user. The machine-readable identifier may include any suitable types of identifiers such as include a barcode, a high-capacity color barcode, a quick-response (QR) code, a radio frequency identification (RFID) tag, a data matrix code, a MaxiCode, an Aztec Code, a PDF417 barcode, a near field communication (NFC) tag, a magnetic strip, among others.

In some embodiments, the machine-readable identifier may be attached to the receptacle stringer device 102. For example, printable machine-readable identifiers such as a QR code or a barcode may be printed and attached to the receptacle stringer device 102. In some embodiments, multiple copies of the same machine-readable identifiers may be printed and/or otherwise manufactured such that multiple receptacle stringer device 102 may be associated with the same user. In some embodiments, the machine-readable identifiers may be removable attached to the receptacle stringer device 102. For example, the machine-readable identifiers such as RFID tags, NFC tags, etc. may be removably attached to the receptacle stringer device 102. Such removable identifiers may be reused across a number of receptacle stringer devices.

In some embodiments, the machine-readable identifier may be integrated as part of the receptacle stringer device 102. For example, the receptacle stringer device 102 may be manufactured with the machine-readable identifiers built in.

In some embodiments, the sensor 104 may be configured to identify the receptacle stringer device 102. For example, the sensor 104 may identify the receptacle stringer device 102 based on the machine-readable identifiers. Additionally or alternatively, the sensor may be configured to identify a number of receptacles attached and/or retained on the receptacle stringer device 102. For example, the sensor 104 may be and/or include one or more optical/image sensors (e.g., cameras, infrared (IR) and near-IR spectrometers, etc.), weight sensors (e.g., scales, balances, etc.), magnetic/electromagnetic sensors, and/or any other sensor capable of identifying/reading a machine-readable identifier and/or identifying/determining the number of receptacles included on the receptacle stringer device 102. For example, a camera may be used to read a QR code and/or to obtain an image of the receptacle stringer device 102 such that a computing device (e.g., via a machine learning (ML) model such as a computer vision (CV) model) may be able to determine the number of receptacles included on the receptacle stringer device 102.

In some embodiments, after the sensor 104 scans/reads at least one machine-readable identifier disposed on the receptacle stringer device 102, the receptacle stringer device 102, including any strung-on receptacles, may be deposited into a container 106 and information related to the deposited receptacle stringer device 102 may be shown on the screen 108.

In some embodiments, the container 106 may be a collection bin or a recycling dumpster. In some embodiments, the container 106 may have wheels to help improve transporting the container 106 to another location. Additionally or alternatively, the container 106 may include one or more handles which may aid in moving the container and/or may make it easier for the container to be lifted (e.g., into a truck to be transported to a recycling center).

In some embodiments, the screen 108 may provide a visual way for the user to interact with the recyclable receptacle collection system. For example, the screen 108 may display account information 110. In some embodiments, the account information 110 may include an account number, name, and/or username. In some embodiments, the account information 110 may include/display information regarding a deposit-refund amount such as how much money should be credited to the user/the specified account and/or where the money should be sent. For example, the screen 108 may indicate account information 110 such as the quantity of the receptacles deposited (e.g., 48), the amount of deposit-refund to be paid (e.g., $4.80), the name of the user (e.g., John Smith), a charity/location the user may select to donate the deposit-refund amount to (e.g., Animal Shelter, Local High School), a business the user may select to get a gift card for the deposit-refund amount to (e.g., This Store, Safety Way), etc. In some embodiments, the screen 108 may display the account information 110 without user interactive components. Additionally or alternatively, the user may interact with the user interface displayed on the screen 108 by touching the screen (e.g., a touchscreen), via buttons, using an application on a personal device (e.g., a smartphone, a tablet computer, etc.), etc.

Modifications, additions, or omissions may be made to the environment 100 without departing from the scope of the disclosure. For example, the designations of different elements in the manner described is meant to help explain concepts described herein and is not limiting. For instance, in some embodiments, the receptacle stringer device 102 is delineated in the specific manner described to help with explaining concepts described herein, but such delineation is not meant to be limiting. Further, the environment 100 may include any number of other elements or may be implemented within other systems or contexts than those described.

FIGS. 2A, 2B, and 2C illustrate example embodiments of a receptacle stringer device 200. For example, FIG. 2A may illustrate a first receptacle stringer device 200a, FIG. 2B may illustrate a second receptacle stringer device 200b, and FIG. 2C may illustrate a third receptacle stringer device 200c. In some embodiments, the first receptacle stringer device 200a, the second receptacle stringer device 200b, and the third receptacle stringer device 200c may be collectively referred to as the receptacle stringer device 200.

In some embodiments, the receptacle stringer device 200 may correspond to the receptacle stringer device 102 of FIG. 1. In some embodiments, the receptacle stringer device 200 may be made primarily (e.g., greater than 50%) of cardboard, plastic, and/or metal. In some embodiments, the material of the receptacle stringer device 200 may substantially correspond to the materials of the receptacles. For example, in instances in which the receptacles include plastic bottles, the receptacle stringer device 200 may be made of plastic.

In some embodiments, the receptacle stringer device 200 may include a rod 202 (e.g., a first rod 202a, a second rod 202b, and a third rod 202c). In some embodiments, the rod 202 may include a first end 204 and a second end 210. In some embodiments, the first end 204 may include a first stopper 206 (e.g., 206a, 206b, and 206c). For example, the first stopper 206 may be attached to the first end 204 of the rod 202. In some embodiments, the first stopper 206 may be a separate part from the rod 202 that is attached to the rod 202. In some embodiments, the first stopper 206 may be a part of the rod 202. For example, the rod and the first stopper 206 may be manufactured as one piece. In some embodiments, the first stopper 206 may be configured to permit one or more receptacles to be strung onto and/or retained on the rod 202 in a first direction 208. For example, the first stopper 206 may be pressed and/or pushed to become narrower to permit the one or more receptacles to pass through the first stopper 206 to be strung onto the rod 202. Unpressed first stopper 206 may not permit the strung receptacles to pass back through the first stopper 206, such that the receptacles are retained on the rod 202. In some embodiments, the rod 202 may be configured to hold multiple receptacles. For example, the rod 202 may be configured to hold at least five, at least ten, at least 20, or more, receptacles such as beverage cans.

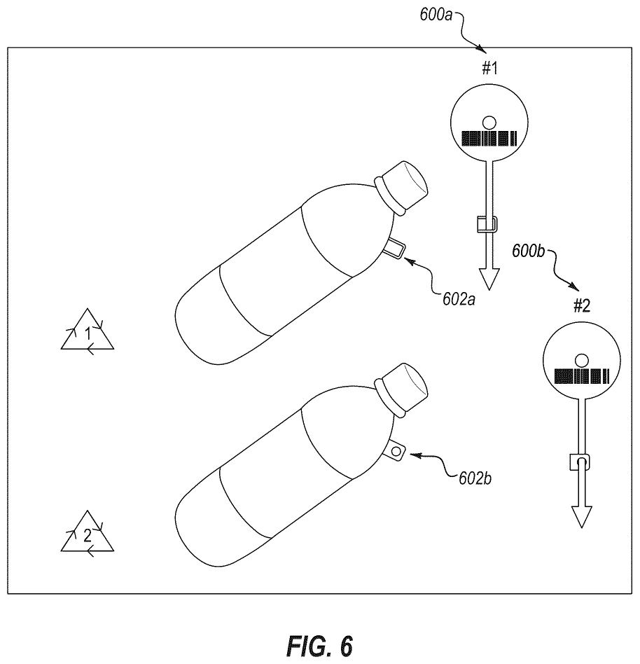

In some embodiments, the rod 202 may have a width configured to accommodate receptacles. For example, in instances in which the receptacles may include beverage cans, the width of the rod 202 may be configured to accommodate tabs of the beverage cans being strung onto the rod 202. For example, the width of the rod 202 may be equal to or smaller than the size of the hole in the tabs of the beverage cans. In some instances, the receptacles may not natively include holes to be used to strung on the receptacle stringer device 200. For example, a traditional plastic bottle may not include a hole. In such instances, a loop may be attached to the receptacles such that the receptacles may be strung on the receptacle stringer device 200 using the loop. Additionally or alternatively, the receptacles (e.g., plastic bottles) may be manufactured with the loop. In some embodiments, the loops attached to bottles may be illustrated and described in further detail with respect to FIG. 6 of the present disclosure.

In some embodiments, the first stopper 206 may be a catch configured to be threaded through a hole in a receptacle such as the tab of an aluminum can or a loop on the lid or side of a plastic bottle. For example, the first stopper 206 may enable receptacles to be strung onto the rod 202 in the first direction 208 and prevent the receptacles from falling off the first end 204 (e.g., in a second direction that is opposite the first direction 208). In some embodiments, the first stopper 206 may be shaped and/or include features configured to help prevent the receptacles from falling off the first end 204 after being strung onto the rod 202. For example, the first stopper 206 may be shaped as a triangle as illustrated in FIGS. 2A-2C. As another example, the first stopper 206 may include one or more barbs. In these and other embodiments, a portion of the first stopper 206 may have a width that is more than the diameter of the hole in the tab/loop of a receptacle, such that the first stopper 206 may help prevent the receptacles from falling off. For instance, the first stopper 206 may have barbs of a width such that at least a portion the first stopper 206 has a width larger than the hole in the tab of an aluminum can. In some embodiments, the first stopper 206 may include at least a portion that is approximately 1 cm, 1.5 cm, 2 cm, or more, in width. In some embodiments, the rod 202 and/or the first stopper 206 may have widths to accommodate receptacles of a particular material type and/or material grade (e.g., a larger width for aluminum cans than for plastic bottles, a larger width for high-density polyethylene (HDPE) plastic bottles than for polyethylene terephthalate (PET) plastic bottles, etc.).

In some embodiments, the rod 202 may include a second stopper 212 (e.g., 212a, 212b, and 212c) at the second end 210 to keep one or more receptacles from coming off the rod 202 at the second end 210 in the first direction 208. In some embodiments, the second stopper 212 may form a closed loop. In these and other embodiments, the second stopper 212 may be configured to facilitate a user picking up and/or holding the device. For example, the second stopper 212 may be shaped like a circle with a hole punched out of the middle of the circle or any other shape that may be used to make a handle. In some embodiments, the second stopper 212 may be built as part of the rod 202. In other embodiments, the second stopper 212 may be a separate piece form the rod 202 that is attached to the rod 202.

In some embodiments, the receptacle stringer device 200 may include a machine-readable identifier 214 (e.g., 214a, 214b, and 214c). In some embodiments, the machine-readable identifier 214 may be located at any suitable locations within the receptacle stringer device 200. In one embodiment, the machine-readable identifier 214 may be located on the second stopper 212. For example, the machine-readable identifier 214 may be attached and/or be integrated as a part of the second stopper 212. In some embodiments, the machine-readable identifier 214 may include a barcode (e.g., the machine-readable identifier 214b of FIG. 2B), a high capacity color barcode (HCCB), a quick-response (QR) code (e.g., the machine-readable identifier 214a of FIG. 2A), a radio frequency identification (RFID) tag (e.g., the machine-readable identifier 214c of FIG. 2C), a data matrix code, a MaxiCode, an Aztec Code, a PDF417 barcode, a near field communication (NFC) tag, a magnetic strip, and/or any other types of identifiers that may be read by a machine.

In some embodiments, the machine-readable identifier 214 may be used to provide quick and easy information to a user of the receptacle stringer device 200 and/or to a recycling system. In some embodiments, the machine-readable identifier 214 may be set up to be associated identification information. In some embodiments, the identification information may include information regarding a user, or a user account associated with the user. In some embodiments, the identification information may include information regarding one or more of material types of the receptacles, and/or material grades of the one or more receptacles. Additionally or alternatively, the identification information may include information regarding a third-party or beneficiary entity.

In some embodiments, the identification information associated machine-readable identifier 214 may be encoded and/or defined using computing devices such as smartphones, tablets, laptops, desktop computers, etc. For example, the machine-readable identifier 214 may be configurable for the encoding of identification information by a user. For example, the user may scan or read the machine-readable identifier 214 with a mobile device (e.g., smartphone) and provide the identification information, such that the particular code may be associated with the user. Such encoding process of the identification information using the mobile devices may permit the users to participate in a recycling system using the receptacle stringer device 200 without additional systems or devices which may help reduce complexity and/or cost of the recycling system. Additionally or alternatively, the machine-readable identifier 214 may include encoded information regarding one or more of material type and/or material grade. For example, the machine-readable identifier 214 may provide information that the receptacles strung onto the receptacle stringer device 200 are made of PET plastic. In some embodiments, the encoded information regarding the material type may be modified and/or customized by the user using the receptacle stringer device 200 to reflect types and/or materials of the receptacles that the user collected using the receptacle stringer device 200.

In some embodiments, the machine-readable identifier 214 may be disposed on the second stopper 212 such that a penetration/hole in the center of the machine-readable identifier 214 may facilitate better storage of the receptacle stringer device 200 while not interfering with the readability of the machine-readable identifier 214 by one or more sensors. For example, a QR code may be missing up to 30% of the code (e.g., to create a handle) and still be scanned by a camera accurately.

In some embodiments, the identification information associated with the machine-readable identifier 214 may include information regarding deposit and/or refund designation. For example, the machine-readable identifier 214 may designate an entity, such as a nonprofit, school, charity, and/or other organizations, such that the deposit refunds (e.g., refunds provided by the recycling system for returning the receptacles) may be donated to the entity. Such designations may improve the accessibility of making donations, which may motivate the users to participate in recycling.

Modifications, additions, or omissions may be made to the receptacle stringer device 200 without departing from the scope of the disclosure. For example, the designations of different elements in the manner described is meant to help explain concepts described herein and is not limiting. For instance, in some embodiments, the receptacle stringer device 200 is delineated in the specific manner described to help with explaining concepts described herein, but such delineation is not meant to be limiting. Further, the receptacle stringer device 200 may include any number of other elements or may be implemented within other systems or contexts than those described.

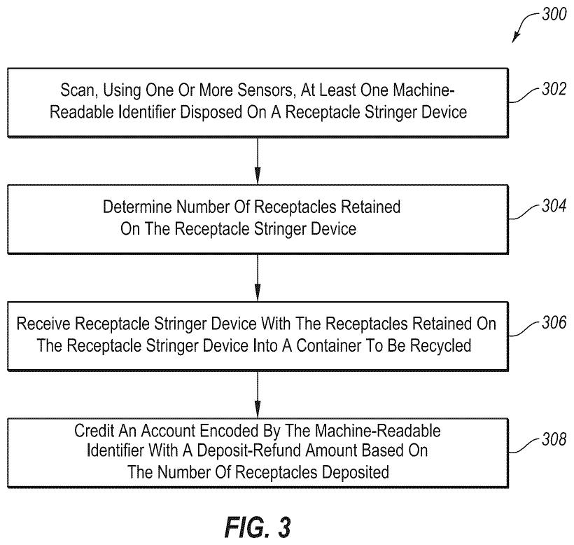

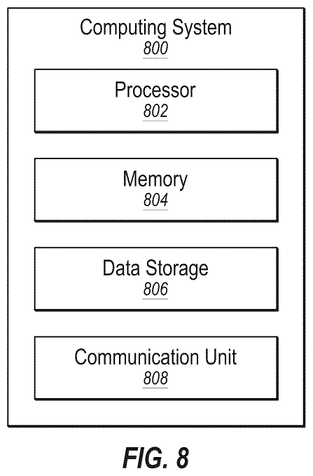

FIG. 3 is a flowchart of an example method 300 of scanning a receptacle stringer device with a machine-readable identifier using a sensor. The method 300 may be performed by any suitable system, apparatus, or device. For example, the method 300 may be implemented in the environment 100 of FIG. 1. Additionally or alternatively, one or more operations of the method 300 may be performed by a computing system, such as that described with respect to FIG. 8. Although illustrated with discrete blocks, the steps and operations associated with one or more blocks of the method 300 may be divided into additional blocks, combined into fewer blocks, or eliminated, depending on the particular implementation. In some embodiments, one or more non-transitory computer readable mediums may be configured to store instructions that when executed result in performing the method 300.

The method 300 may include block 302. At block 302, a recycling system may scan, using one or more sensors, at least one machine-readable identifier disposed on a receptacle stringer device. In some embodiments, the recycling system may obtain the information associated with the machine-readable identifier. For example, the recycling system may obtain information regarding a user of the receptacle stringer device, receptacles retained by the receptacle stringer device, etc. In some embodiments, the recycling system may correspond to the recyclable receptacle collection system of FIG. 1, and the receptacle stringer device may correspond to the receptacle stringer device 102 of FIG. 1 and the receptacle stringer device 200 of FIGS. 2A-2C.

At block 304, the recycling system may determine a number of receptacles retained on the receptacle stringer device. In some embodiments, the number of receptacles may be determined using the one or more sensors. For example, the one or more sensors may include a camera configured to determine the number of receptacles using computer vision techniques. As another example, the one or more sensors may include weight sensors configured to weight the receptacles to determine the number of receptacles. For example, the recycling system may have a database including known, average, or common weights of different receptacles (e.g., plastic bottlers, aluminum cans, etc.). The recycling system may compare the measured weight against the known weights to determine the number of the receptacles. In some embodiments, the number of receptacles determined based on the weight may be verified using another approach (e.g., computer vision) such that the weight may not be altered (e.g., by putting weights, such as rocks, in the receptacles).

At block 306, the recycling system may receive the receptacle stringer device with the receptacles retained on the receptacle stringer device. For example, the recycling system may receive the device and the receptacles at a container. For example, the user may drop the device and the receptacles into the container. In some embodiments, the recycling system may be configured to verify that the device and the receptacles were actually received in the container. For example, the recycling system may be configured to keep track of weigh of the contents inside the container. In response to receiving the device and the receptacles, the recycling system may compare the new weight (e.g., including the newly added device and the receptacles) to the previous weight to verify that the device and the receptacles were properly received.

At block 308, an account encoded by machine-readable identifier included on the receptacle stringer device may be credited with a deposit-refund amount based on the number of receptacles deposited. In some embodiments, the machine-readable identifier may be associated with a user account, and the deposit-refund amount may be credited to the user account. In these and other embodiments, the user may transfer the credited amount out of the user account, such that the credited amount may be cashed out. For example, the user may request to transfer the credited amount to a bank account. In other embodiments, the credited amount may be automatically deposited to the bank account associated with the user. In some instances, the machine-readable identifier may be associated with a particular entity, such as a nonprofit, school, charity, and/or other organizations. In such instances, the deposit-refund amount may be credited to and/or transferred to an account associated with the particular entity.

Modifications, additions, or omissions may be made to the method 300 without departing from the scope of the disclosure. For example, the designations of different elements in the manner described is meant to help explain concepts described herein and is not limiting. Further, the method 300 may include any number of other elements or may be implemented within other systems or contexts than those described.

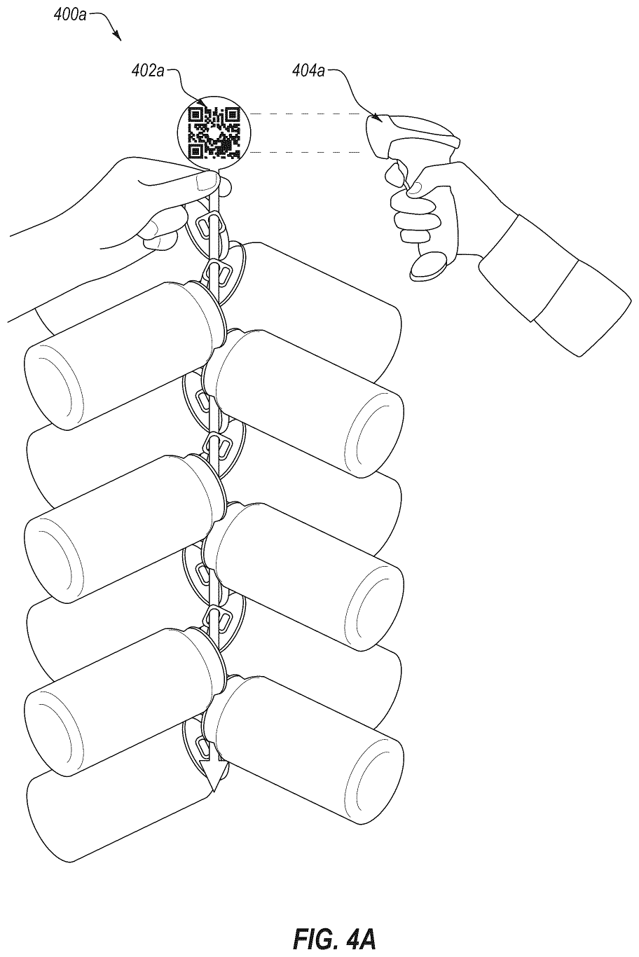

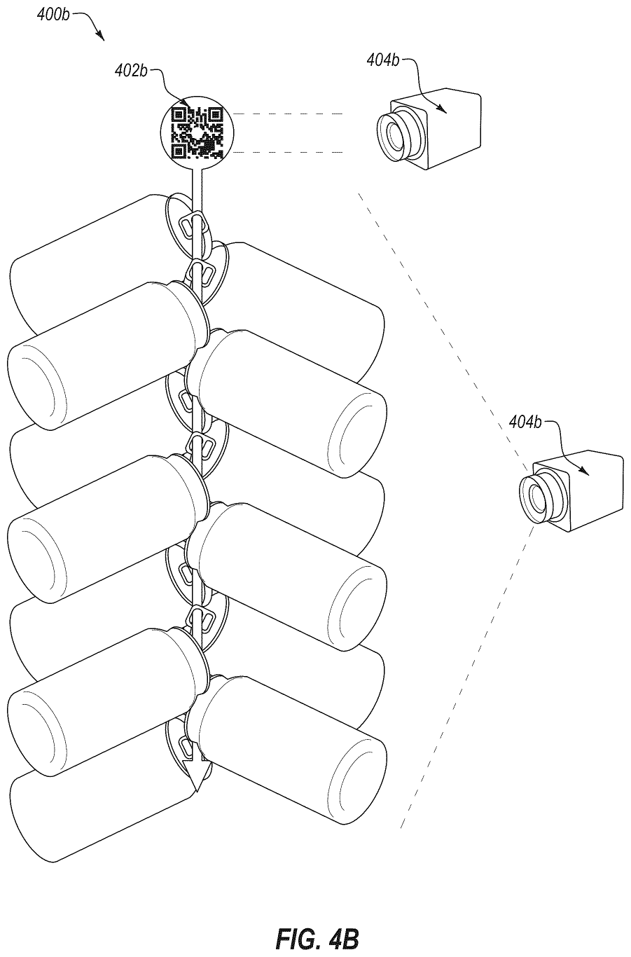

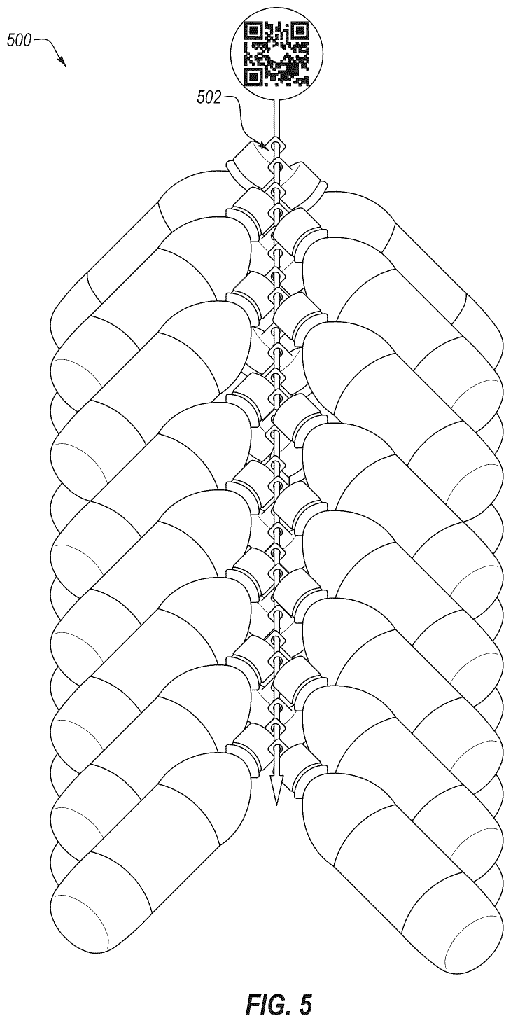

FIGS. 4A and 4B illustrate fully loaded/strung receptacle stringer devices 400a, 400b (a receptacle stringer device 400), in accordance with one or more embodiments of the present disclosure. In some embodiments, the receptacle stringer device 400 may include machine-readable identifiers 402a, 402b (a machine-readable identifier 402) by one or more sensors 404 (e.g., an example handheld sensor 404a in FIG. 4A and by example fixed location sensors 404b in FIG. 4B).

In some embodiments, the one or more sensors 404 may be used to scan each receptacle and/or may photograph the receptacles such that the total number of receptacles strung onto a receptacle stringer device 400 may be determined. In some embodiments, the one or more sensors 404 may be a mobile device. For example, a camera on the mobile device may be used to capture information of the receptacles and/or the receptacle stringer device 400. Additionally or alternatively, the one or more sensors may be a feature, application, accessory, and/or attachment that may be used with the mobile device. In some embodiments, the one or more sensors 404 may be used at a collection center/location where several containers of recyclable receptables may be grouped, sorted, etc.

In some embodiments, a person or an employee associated with the recycling system may use the one or more sensors 404 to wirelessly record and process the receptacle stringer device 400. In some embodiments, to expedite the process, an electronic system may electronically determine and record the quantity of receptacles included on a receptacle stringer device 400 prior to the receptacles continuing in a recycling process. For example, the one or more sensors 404 may be used in a remote location such that the person may not need to be present for a user to scan and/or deposit the receptacle stringer device 400 to be recycled. In some embodiments, electronic information retrieved and/or recorded by the one or more sensors 404 may allow for locations that have fees related to container deposit laws (e.g., states with “bottle bills”) to efficiently reimburse the user the redemption value for each receptacle included on a deposited receptacle stringer device 400.

Modifications, additions, or omissions may be made to the receptacle stringer device 400 without departing from the scope of the disclosure. For example, the designations of different elements in the manner described is meant to help explain concepts described herein and is not limiting. For instance, in some embodiments, the receptacle stringer device 400 is delineated in the specific manner described to help with explaining concepts described herein, but such delineation is not meant to be limiting. Further, the receptacle stringer device 400 may include any number of other elements or may be implemented within other systems or contexts than those described.

FIG. 5 illustrates an example receptacle stringer device 500, in accordance with one or more embodiments of the present disclosure. In some embodiments, the receptacle stringer device 500 may be configured to have plastic beverage containers strung onto the receptacle stringer device 500. In these and other embodiments, the plastic beverage containers may include a loop 502 (e.g., a tab, hook, bend, coil, etc.) configured to allow plastic beverage containers to be strung onto the receptacle stringer device 500. For example, a small loop may be included on the side of or on the top of a cap/lid to the plastic beverage containers.

Modifications, additions, or omissions may be made to the receptacle stringer device 500 without departing from the scope of the disclosure. For example, the designations of different elements in the manner described is meant to help explain concepts described herein and is not limiting. For instance, in some embodiments, the receptacle stringer device 500 is delineated in the specific manner described to help with explaining concepts described herein, but such delineation is not meant to be limiting. Further, the receptacle stringer device 500 may include any number of other elements or may be implemented within other systems or contexts than those described.

FIG. 6 illustrates example receptacle stringer devices, in accordance with one or more embodiments of the present disclosure. In some embodiments, FIG. 6 illustrates a first receptacle stringer device 600a and a second receptacle stringer device 600b. The first receptacle stringer device 600a and the second receptacle stringer device 600b may be collectively referred to as “the receptacle stringer devices 600. In some embodiments, the receptacle stringer devices 600 may be configured to accommodate different types of materials and/or different material grades. For example, the receptacle stringer devices 600 may have varying widths corresponding to different materials and/or grades of materials. For example, the first receptacle stringer device 600a and the second receptacle stringer device 600b may have different widths.

In some embodiments, the different widths may correspond to different loops having different sizes and/or materials. For example, the first receptacle stringer device 600a may have a first width and/or be made of a first material corresponding to a first loop 602a attached to a first bottle, and the second receptacle stringer device 600b may have a second width and/or be made of a second material corresponding to a second loop 602b attached to a second bottle. For instance, the first bottle may be a PET plastic bottle, and the second bottle may be a HDPE plastic bottle in which instances, the first loop 602a and the second loop 602b may be made of corresponding materials. In such instances, the first receptacle stringer device 600a may be made of PET plastic bottle and the second receptacle stringer device 600b may be made of HDPE plastic bottle. Additionally or alternatively, the first receptacle stringer device 600a may have the first width corresponding to (e.g., configured retain the bottle without the bottle falling off) the first inner width of the first loop 602a, and the second receptacle stringer device 600b may have the second width corresponding to a second inner width of the second loop 602b.

In some embodiments, the first inner width of the first loop 602a and the second inner width of the second loop 602b may be determined based on material of the first bottle and the second bottle, respectively. For example, the first inner width of the first loop 602a attached to the first bottle made of higher-grade plastics (e.g., clear PET) may be larger than the second inner width of the second loop 602b attached to the second bottle made of lower-grade plastics (e.g., milky/solid color HDPE). In these and other embodiments, the disclosed system may be used to collect, grade, sort, and/or provide reimbursement for a variety of plastics in a recycling system.

Modifications, additions, or omissions may be made to the receptacle stringer devices 600 without departing from the scope of the disclosure. For example, the designations of different elements in the manner described is meant to help explain concepts described herein and is not limiting. For instance, in some embodiments, the receptacle stringer device 600 is delineated in the specific manner described to help with explaining concepts described herein, but such delineation is not meant to be limiting. Further, the receptacle stringer device 600 may include any number of other elements or may be implemented within other systems or contexts than those described.

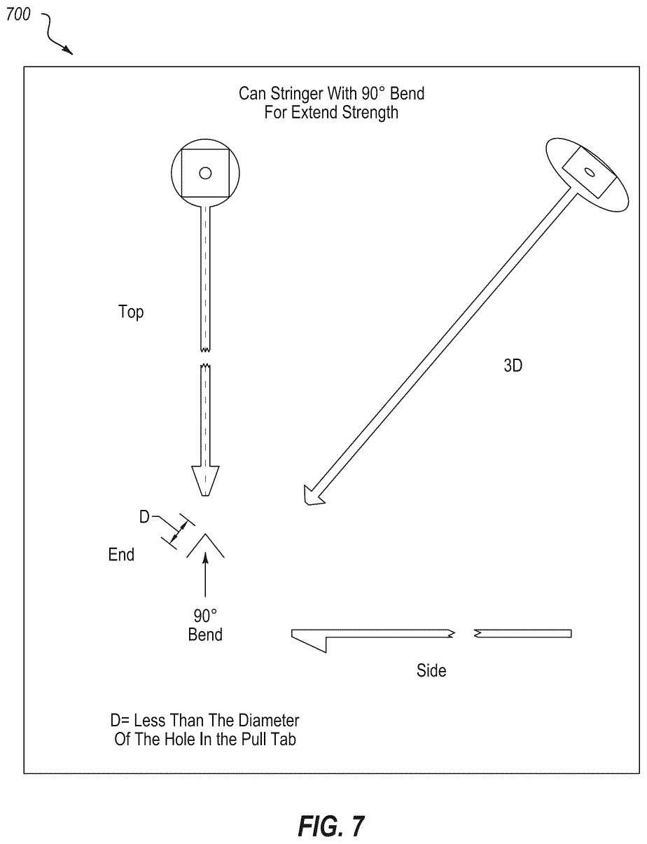

FIG. 7 illustrates an example receptacle stringer device 700 according to one or more embodiments of the present disclosure. In some embodiments, the receptacle stringer device 700 may include an approximately 90-degree bend in the rod such that additional strength is provided. In these and other embodiments, the receptacle stringer device 700 may be better suited to carrying more receptacles without breaking. In some embodiments, the receptacle stringer device 700 with an approximately 90-degree bend may be primarily made of cardboard. In these and other embodiments, the diameter of the receptacle stringer device 700 may be less than the diameter of the hole in a pull tab of an aluminum can.

Modifications, additions, or omissions may be made to the receptacle stringer device 700 without departing from the scope of the disclosure. For example, the designations of different elements in the manner described is meant to help explain concepts described herein and is not limiting. For instance, in some embodiments, the receptacle stringer device 700 is delineated in the specific manner described to help with explaining concepts described herein, but such delineation is not meant to be limiting. Further, the receptacle stringer device 700 may include any number of other elements or may be implemented within other systems or contexts than those described.

FIG. 8 is an example computing system 800 according to one or more embodiments of the present disclosure. The computing system 800 may include a processor 802, a memory 804, a data storage 806, and/or a communication unit 808, which all or one or more of may be communicatively coupled. For example, the one or more sensors 404 of FIG. 4 may be implemented as or configured to utilize a computing system consistent with the computing system 800.

Generally, the processor 802 may include any suitable special-purpose or general-purpose computer, computing entity, or processing device including various computer hardware or software modules and may be configured to execute instructions stored on any applicable computer-readable storage media. For example, the processor 802 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 8, it is understood that the processor 802 may include any number of processors distributed across any number of network or physical locations that are configured to perform individually or collectively any number of operations described in the present disclosure. In some embodiments, the processor 802 may interpret and/or execute program instructions and/or process data stored in the memory 804, the data storage 806, or the memory 804 and the data storage 806. In some embodiments, the processor 802 may fetch program instructions from the data storage 806 and load the program instructions into the memory 804.

After the program instructions are loaded into the memory 804, the processor 802 may execute the program instructions, such as instructions to cause the computing system 800 to perform some of the operations of the method 300 of FIG. 3. For example, the computing system 800 may execute the program instructions to scan, using one or more sensors, at least one machine-readable identifier disposed on a receptacle stringer device; to determine the number of receptacles strung onto the receptacle stringer device; and/or credit an account encoded by the machine-readable identifier with a deposit-refund amount based on the number of receptacles deposited of the method 300 of FIG. 3.

The memory 804 and the data storage 806 may include computer-readable storage media or one or more computer-readable storage mediums for having computer-executable instructions or data structures stored thereon. Such computer-readable storage media may be any available media that may be accessed by a general-purpose or special-purpose computer, such as the processor 802. In some embodiments, the computing system 800 may or may not include either of the memory 804 and the data storage 806.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 802 to perform a particular operation or group of operations.

The communication unit 808 may include any component, device, system, or combination thereof that is configured to transmit or receive information over a network. In some embodiments, the communication unit 808 may communicate with other devices at other locations, the same location, or even other components within the same system. For example, the communication unit 808 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 808 may permit data to be exchanged with a network and/or any other devices or systems described in the present disclosure. For example, the communication unit 808 may allow the computing system 800 to communicate with other systems, such as computing devices and/or other networks.

One skilled in the art, after reviewing this disclosure, may recognize that modifications, additions, or omissions may be made to the computing system 800 without departing from the scope of the present disclosure. For example, the computing system 800 may include more or fewer components than those explicitly illustrated and described.

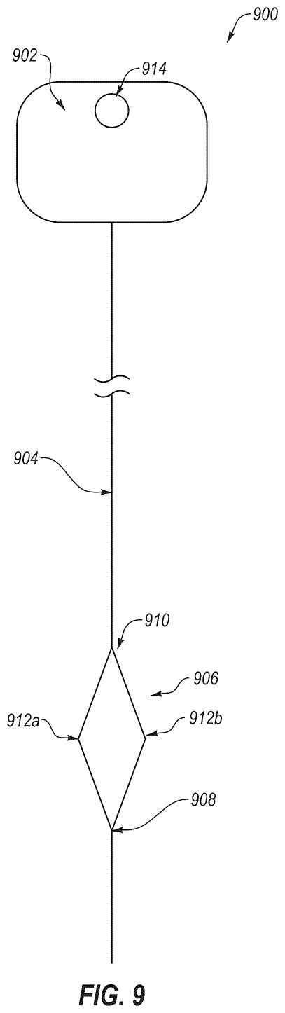

FIG. 9 illustrates another example receptacle stringer device 900 according to one or more embodiments of the present disclosure. The receptacle stringer device 900 illustrates an example of a receptacle stringer device configured for easier removal of receptacles. In these and other embodiments, the easier removal of the receptacles may permit the receptacle stringer device 900 to be reused. In some embodiments, the receptacle stringer device 900 includes a first stopper 902, a second stopper 906, and a rod 904 extending between the first stopper 902 and the second stopper 906. In some embodiments, the receptacle stringer device 900 may be configured to receive one or more receptacles (e.g., beverage cans, plastic bottles, etc.) and to retain the one or more receptacles within the receptacle stringer device 900. In these and other embodiments, the one or more receptacles may include tap and/or a loop with a hole, such that the receptacle stringer device 900 may retain the one or more receptacles via the holes in the tab/loop of the one or more receptacles. In some embodiments, the receptacle stringer device 900 may include varying dimensions suitable for retaining the one or more receptacles. For example, in instances in which the one or more receptacles include aluminum beverage containers, the receptacle stringer device 900 may be ten inches long to hold approximately twelve cans or one case of containers. In some embodiments, the receptacle stringer device 900 may be twenty inches long to hold approximately 24 cans or two cases of containers. In some embodiments, the receptacle stringer device 900 may be 30 inches long to hold approximately 36 cans which have an approximate weight of 1 pound. The length is provided merely as an example, and the receptacle stringer device 900 may have any suitable lengths.

In some embodiments, the first stopper 902 may be configured to retain or prevent the one or more receptacles from falling off the receptacle stringer device 900 past the first stopper 902. For example, the first stopper 902 may have a width greater than the diameter of the hole in the tab/loop of the one or more receptacles, such that the one or more receptacles do not fall off the receptacle stringer device 900 past the first stopper 902. For example, in some embodiments, the first stopper 902 may be 2 inches wide and 1.5 inches long.

In some embodiments, the first stopper 902 may include a machine-readable identifier such as the machine-readable identifier 214 of FIGS. 2A-2C. In some embodiments, the first stopper 902 may be configured to facilitate a user picking up and/or holding the receptacle stringer device 900. For example, the first stopper 902 may include a hole 914 punched out of the first stopper 902. In some embodiments, the hole 914 may be sized such that the hole 914 may be used for carrying the receptacle stringer device 900. For example, in some embodiments, the hole 914 may have a diameter of 0.375 inches. In some embodiments, the first stopper 902 and/or the hole 914 may be shaped and/or sized differently. For example, the first stopper 902 may be shaped as a circle, a square, a rectangle, a rounded rectangle, etc. The hole 914 may be shaped as any shapes that may be used to make a handle.

In some embodiments, the receptacle stringer device 900 may receive the one or more receptacles via the second stopper 906. For example, the one or more receptacles may thread through or past the second stopper 906 to reach the rod 904. In these and other embodiments, the second stopper 906 may include a first end 908, a second end 910, and a body 912 extending between the first end 908 and the second end 910. In some embodiments, the body 912 may be 2 inches long (e.g., length between the first end 908 and the second end 910). In these and other embodiments, the body 912 may include a first body 912a and a second body 912b (collectively referred to as the body 912). The first body 912a and the second body 912b may each separately extend between the first end 908 and the second end 910. In these and other embodiments, the first body 912a and the second body 912b may extend away from each other at an angle then back toward each other while extending between the first end 908 and the second end 910, such that the body 912 includes an air gap or a bulge.

In some embodiments, a width of the air gap between the first body 912a and the second body 912b may be greater than the width of the rod 904. For example, in some embodiments, the width of the air gap between the first body 912a and the second body 912b may be around 0.625 inches or around 1.5 cm. Contrastingly, in some embodiments, the diameter of the rod 904 may be around 0.065 inches. In these and other embodiments, the air gap between the first body 912a and the second body 912b may be sized and/or shaped such that at least a part of the air gap between the first body 912a and the second body 912b is greater than the diameter of the hole in the tab/loop of the one or more receptacles retained by the receptacle stringer device 900. For example, in these and other embodiments, the diameter of the hole in the tab/loop of the one or more receptacles may be greater than 0.065 inches but smaller than 0.625 inches. In some embodiments, the rod 904 may have varying lengths suitable to retain the one or more receptacles. For example, in some embodiments, the rod 904 may be 20 inches long.

In some embodiments, the body 912 may be configured such that pressing on the first body 912a and the second body 912b may move the first body 912a and the second body 912b closer, reducing the width of the air gap between the first body 912a and the second body 912b. Additionally or alternatively, in some embodiments, the second stopper 906 may be pulled such that the width of the air gap between the first body 912a and the second body 912b may be reduced. For example, the first end 908 and the second end 910 of the second stopper 906 may be pulled in opposite directions, which may pull the first body 912a and the second body 912b together. For example, the first end 908 may be pulled downward and the second end 910 may be pulled upward (or in any other opposite directions such as left and right), such that the first body 912a and the second body 912b may move toward each other. In some embodiments, only one of the first end 908 or the second end 910 may be pulled. For example, pulling only the first end 908 away from the second end 910 may move the first body 912a and the second body 912b closer to each other, reducing the width of the air gap.

In these and other embodiments, the width of the air gap between the first body 912a and the second body 912b may be reduced to be narrower or smaller than the diameter of the hole in the tab/loop of the receptacles. In these and other embodiments, the one or more receptacles may be threaded through the second stopper 906 (e.g., enter through the first end 908 and exit through the second end 910 to reach the rod 904). In response to the one or more receptacles reaching the rod 904, the second stopper 906 or the body 912 may be released such that the width of the air gap is restored (e.g., to be greater than the diameter of the hole in the tab/loop of the receptacles).

In some embodiments, the width of the air gap between the first body 912a and the second body 912b may be reduced by threading or pushing the one or more receptacles toward and past the first end 908 of the second stopper 906 may cause the first body 912a and the second body 912b to move closer. In these and other movements, the width of the air gap may be reduced without separately pulling and/or pushing the first body 912a and the second body 912b.

In some embodiments, the design and/or shape of the receptacle stringer device 900 may improve reuse of the receptacle stringer device 900. For instance, removing the one or more receptacles from the receptacle stringer device 900 may be improved. For example, a user of the receptacle stringer device 900 may pull the receptacle stringer device while a device or a person (e.g., the user or another person) retains the one or more receptacles. For example, pulling on the receptacle stringer device 900 while holding onto or retaining the one or more receptacles may cause the air gap between the first body 912a and the 912b to decrease, causing the one or more receptacles to be removed from the receptacle stringer device 900, leaving the user with the receptacle stringer device 900 to reuse.

Modifications, additions, or omissions may be made to the receptacle stringer device 900 without departing from the scope of the disclosure. For example, the designations of different elements in the manner described is meant to help explain concepts described herein and is not limiting. For instance, in some embodiments, the receptacle stringer device 900 is delineated in the specific manner described to help with explaining concepts described herein, but such delineation is not meant to be limiting. Further, the receptacle stringer device 900 may include any number of other elements or may be implemented within other systems or contexts than those described.

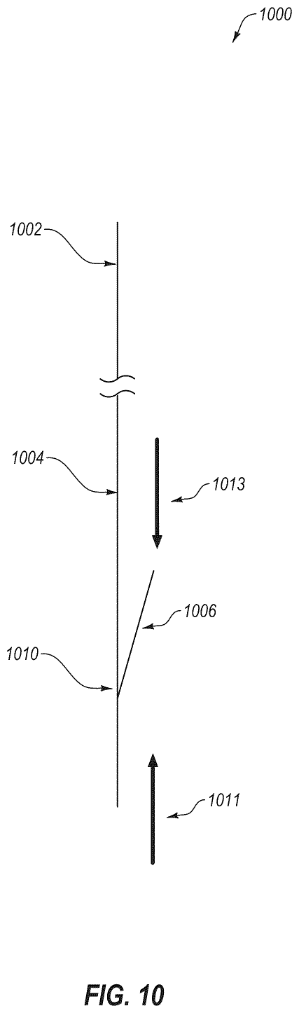

FIG. 10 illustrates another example receptacle stringer device 1000 according to one or more embodiments of the present disclosure. The receptacle stringer device 1000 may be configured to receive, retain, transport, and/or release one or more receptacles such as cans, bottles, etc. In some embodiments, the receptacle stringer device 1000 may include a rod 1004 having a first end 1002 and a second end 1010. Although not illustrated, in some embodiments, the first end 1002 may include a first stopper such as the first stopper 902 of FIG. 9. For example, the first stopper may be configured to prevent one or more receptacles from falling off the receptacle stringer device 1000 past in a first direction 1011. In some embodiments, the second end 1010 may include a second stopper 1006.

In some embodiments, the second stopper 1006 may be configured to prevent the one or more receptacles from falling off the receptacle stringer device 1000 in a second direction 1013. For example, the second stopper 1006 may help retain the one or more receptacles on the rod 1004 of the receptacle stringer device 1000. In some embodiments, the second stopper 1006 may extend from the rod 1004 at an angle toward the first direction 1011. In these and other embodiments, the second stopper 1006 may extend from the rod 1004 such that there is an air gap between the rod 1004 and the second stopper 1006. In some embodiments, the receptacle stringer device 1000 may receive the one or more receptacles past the second stopper 1006. For example, the second stopper may be pushed down toward the rod 1004, causing the air gap between the rod 1004 and the second stopper 1006 to be reduced, such that a hole in the tab/loop of the one or more receptacles may be threaded onto the rod 1004 past the second stopper 1006.

In some embodiments, pushing the one or more receptacles toward the second stopper 1006 in the first direction 1011 toward the second stopper 1006 may push down the second stopper 1006, reducing the air gap, such that the one or more receptacles may be threaded onto the rod 1004 past the second stopper 1006. In response to the one or more receptacles passing past the second stopper 1006, the second stopper 1006 may be released back to the original position, restoring the air gap (such as illustrated in FIG. 10). In these and other embodiments, the second stopper 1006 in the original position may help prevent the one or more receptacles retained on the rod 1004 from falling off the rod 1004 past the second stopper 1006 in the second direction 1013. In these and other embodiments, the second stopper 1006 may help retain the one or more receptacles more securely, such that the one or more receptacles are not easily removed from the receptacle stringer device 1000. Although the second stopper 1006 is illustrated as having a certain length and at a certain angle with respect to the rod 1004, the second stopper may be configured with various lengths and angles with respect to the rod 1004. Additionally, the second stopper 1006 may have various widths and/or diameters suitable to retain the one or more receptacles.

Modifications, additions, or omissions may be made to the receptacle stringer device 1000 without departing from the scope of the disclosure. For example, the designations of different elements in the manner described is meant to help explain concepts described herein and is not limiting. For instance, in some embodiments, the receptacle stringer device 1000 is delineated in the specific manner described to help with explaining concepts described herein, but such delineation is not meant to be limiting. Further, the receptacle stringer device 1000 may include any number of other elements or may be implemented within other systems or contexts than those described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A device comprising:
a rod comprising a first end and a second end;
a first stopper attached to the first end of the rod, the first stopper configured to:
permit one or more receptacles to be strung on the rod in a first direction; and
prevent the one or more receptacles from falling off of the rod in a second direction;
a second stopper attached to the second end of the rod, the second stopper configured to prevent the one or more receptacles from coming off the rod in the first direction; and
one or more machine-readable identifiers disposed on at least one of the rod, the first stopper, or the second stopper, and configurable for encoding of identification information.

2. The device of claim 1, wherein the one or more machine-readable identifiers comprise one or more of a barcode, a high-capacity color barcode, a quick-response code, a radio frequency identification tag, a data matrix code, a MaxiCode, an Aztec Code, a PDF417 barcode, a near field communication tag, or a magnetic strip.

3. The device of claim 1, wherein the identification information includes user information or user account information.

4. The device of claim 1, wherein the identification information includes information regarding one or more of material types of the one or more receptacles, or material grades of the one or more receptacles.

5. The device of claim 1, wherein the identification information includes information associated with one or more beneficiary entities.

6. The device of claim 1, wherein the rod, the first stopper, and the second stopper are manufactured as one piece.

7. The device of claim 1, wherein the first stopper has a first width, the second stopper has a second width, and the rod has a third width, the third width being smaller than the first width and the second width.

8. The device of claim 7, wherein the third width of the rod is determined based on types of the one or more receptacles.

9. The device of claim 8, wherein the one or more receptacles include aluminum cans and the third width of the rod is determined to accommodate tabs of the aluminum cans.

10. The device of claim 1, wherein the device is built using a material relatively similar to material type of the one or more receptacles.

11. The device of claim 1, wherein the device is made primarily of cardboard, plastic, or metal.

12. The device of claim 1, wherein the second stopper forms a closed loop.

13. The device of claim 12, wherein the second stopper is configured to facilitate a user holding the device.

14. A system comprising:
the device of claim 1;
one or more sensors configured to capture the one or more machine-readable identifiers; and
a computing device configured to decode the identification information encoded with the one or more machine-readable identifiers.

15. A system comprising:
the device of claim 1; and
the one or more receptacles.

16. The system of claim 15, wherein the one or more receptacles are made primarily of one or more of aluminum, brass, bronze, cast iron, copper, steel, tin, glass, plastic, paper, or cardboard.

17. The system of claim 15, wherein the one or more receptacles comprise a plastic bottle comprising at least one loop configured to removably attach the plastic bottle to the rod.

18. A method comprising:
scanning, using one or more sensors, at least one machine-readable identifier disposed on a receptacle stringer device;
determining a number of receptacles retained on the receptacle stringer device;
receiving the receptacle stringer device with the receptacles retained on the receptacle stringer device into a container to be recycled; and
crediting an account encoded by the machine-readable identifier with a deposit-refund amount based on the number of the one or more receptacles received.

19. The method of claim 18, wherein the receptacles are made primarily of one or more of aluminum, brass, bronze, cast iron, copper, steel, tin, glass, plastic, paper, or cardboard.

20. One or more non-transitory computer-readable storage media configured to store instructions that, in response to being executed, cause a system to perform operations, the operations comprising:
scanning, using one or more sensors, at least one machine-readable identifier disposed on a receptacle stringer device;
determining a number of receptacles retained on the receptacle stringer device;
receiving the receptacle stringer device with the receptacles retained on the receptacle stringer device into a container to be recycled; and
crediting an account encoded by the machine-readable identifier with a deposit-refund amount based on the number of the one or more receptacles received.
